(19) United States
(12) Patent Application Publication
(10) Pub. No.: US 2005/0019194 A1
(43) Pub. Date: Jan. 27, 2005

(54) Scroll compressor pumping structure

(75) Inventors: Guang-Der Tarng, Taoyuan Hsien (TW); Lung-Tsai Chang, Taoyuan Hsien (TW); Mu-Ching Yeh, Taoyuan Hsien (TW)

Correspondence Address: TROXELL LAW OFFICE PLLC, SUITE 1404, 5205 LEESBURG PIKE, FALLS CHURCH, VA, 22041, US

(73) Assignee: Rechi Precision Co., Ltd.

(21) Appl. No.: 10/626,798

(22) Filed: Jul. 25, 2003

(51) Int. Cl. F01C 1/02; F01C 1/063; F03C 2/00; F04C 2/00

(52) U.S. Cl. 418/55.3

(57) ABSTRACT

An improved pumping structure of a scroll compressor having multiple positioning seats fixed to the block at where in relation to the circumference of a fixed scroll, and a suppressor being fixed at the top of the positioning seat to secure the fixed scroll to the block; an Oldham ring being provided between an orbiting scroll and the block for the limiting part of the Oldham ring to limit the operation direction of the orbiting scroll is characterized by that the positioning base being fixed to the block with a stand ring, and the stand ring being coupled to the block after the block is fixed where inside the casing to minimize the impacts upon the assembly precision of the positioning seat and the fixed scroll due to deformation of the mechanical structure in the assembly process of the block and casing.

### BACKGROUND OF THE INVENTION

(a) Field of the Invention

The present invention is related to an improved structure of a scroll compressor, and more particularly, to one that holds the fixed scroll in position and limits the orbiting scroll to only revolve around the fixed scroll without revolving on its own axis so to minimize the impacts upon the precision of the positioning seat and the fixed scroll due to possible deformation of the mechanical structure in the assembly process of the block and casing.

(b) Description of the Prior Art

Scroll compressors generally available in the market operate by having an orbiting scroll to revolve around a fixed scroll inside a casing to gradually and inwardly increase the pressure of multiple compression chambers to induce changed volume of those chambers, thus to compress the coolant. A block is fixed inside the casing and in turn the block is fixed to the fixed scroll while the orbiting scroll is provided between the fixed scroll and the block to revolve around the fixed scroll.

As illustrated in FIG. 1 of the accompanying drawings, a fixation means for the scroll compressor is used to hold the fixed scroll (40) in position and to limit the orbiting scroll (30) only to revolve around the fixed scroll (40) without revolving around its own axis. Wherein, multiple positioning seats (20) are fixed to the block (10) in relation to the circumference of the fixed scroll (40). Corresponding suppressors (50) are respectively provided at the top of each of those positioning seats (20) to secure both of the fixed scroll (40) and the block (10). An Oldham ring is separately provided at where between the orbiting scroll (30) and the block (10) to limit the direction of the movement of the orbiting scroll (30).

A bolt (60) is used to lock the suppressor (50) to the positioning seat (20) for the suppressor (50) to suppress upon the fixed scroll (40) and the block (10). Therefore, corresponding through holes (51) and locking holes (21) are respectively provided on the suppressor (5) and the positioning seat (20) for the insertion of bolts (60). Furthermore, the fixation means of the prior art has the positioning seats (20) and the block (10) integrated in one piece while the block (10) is further to be fixed inside the casing by welding. During the assembly of the block and the casing, the mechanical structure of the block (10) is vulnerable to be changed due to improperly exercised external force or the high temperature generated in the course of the welding job, resulting in deformation and/or slant of the positioning seat (20) as illustrated in FIG. 2, to fail maintaining an ideal spacing between the fixed scroll (40) and the positioning seat (20) as expected, thus to serious affect the operation quality of the entire compressor.

### SUMMARY OF THE INVENTION

The primary purpose of the present invention is to provide an improved pumping structure of a scroll compressor to help minimize the impacts upon the assembly precision of the positioning seat and the fixed scroll due to deformation of the mechanical structure in the assembly process of the block and casing. To achieve the purpose, multiple positioning seats of the prior art are fixed to the block at where in relation to the circumference of the fixed scroll, a suppressor is fixed to the top of each positioning seat to secure both of the fixed scroll and the block, and an Oldham ring is separately provided at where between the orbiting scroll and the block to have its limiting part to limit the direction of the movement of the orbiting scroll. Furthermore, a stand ring is fixed onto the block after the block has been fixed to where inside the casing.

### BRIEF DESCRIPTION OF THE DRAWINGS

FIG. 1 is a perspective view of a structure of a fixation means of the prior art.

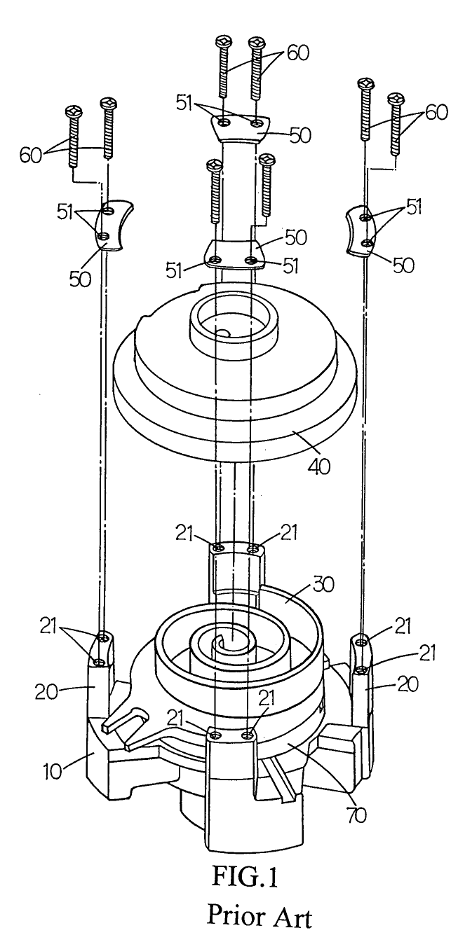

FIG. 2 is a sectional view showing how the fixation means of the prior is coupled to a fixed scroll.

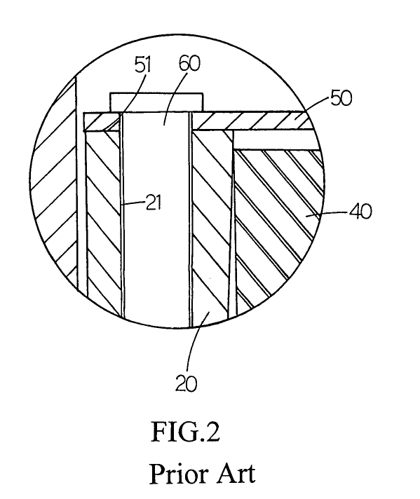

FIG. 3 is an exploded view of a fixation means of a preferred embodiment of the present invention.

FIG. 4 is a sectional view showing how the fixation means of the preferred embodiment of the present invention is coupled to an orbiting scroll, the fixed scroll, and the block.

FIG. 5 is an exploded view of a fixation means of a second preferred embodiment of the present invention.

FIG. 6 is a sectional view showing how the fixation means of the second preferred embodiment of the present invention is coupled to an orbiting scroll, the fixed scroll, and the block.

FIG. 7 is a sectional view showing how the fixation means of a third preferred embodiment yet of the present invention is coupled to an orbiting scroll, the fixed scroll, and the block.

FIG. 8 is a sectional view showing how the fixation means of a fourth preferred embodiment yet of the present invention is coupled to an orbiting scroll, the fixed scroll, and the block.

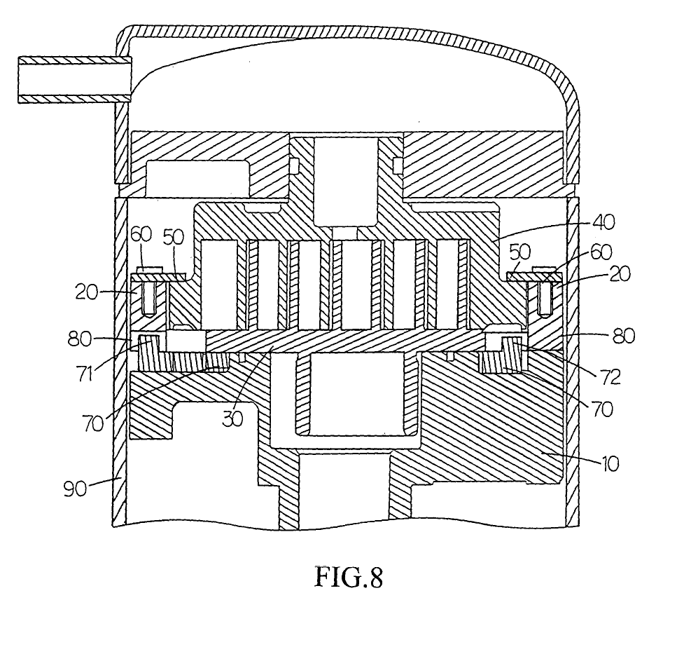

FIG. 9 is a sectional view of a fifth preferred embodiment of the fixation means of the present invention.

FIG. 10 is a sectional view of a sixth preferred embodiment of the fixation means of the present invention.

FIG. 11 is an exploded view of the structure of the block and the Oldham ring.

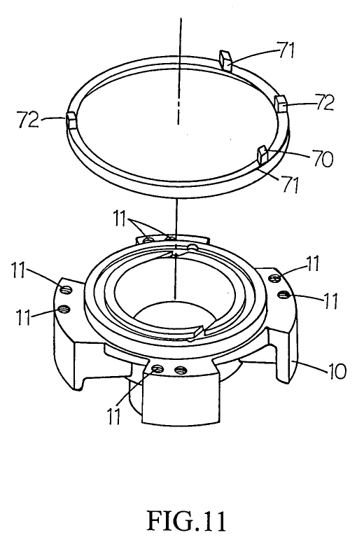

### DETAILED DESCRIPTION OF THE PREFERRED EMBODIMENTS

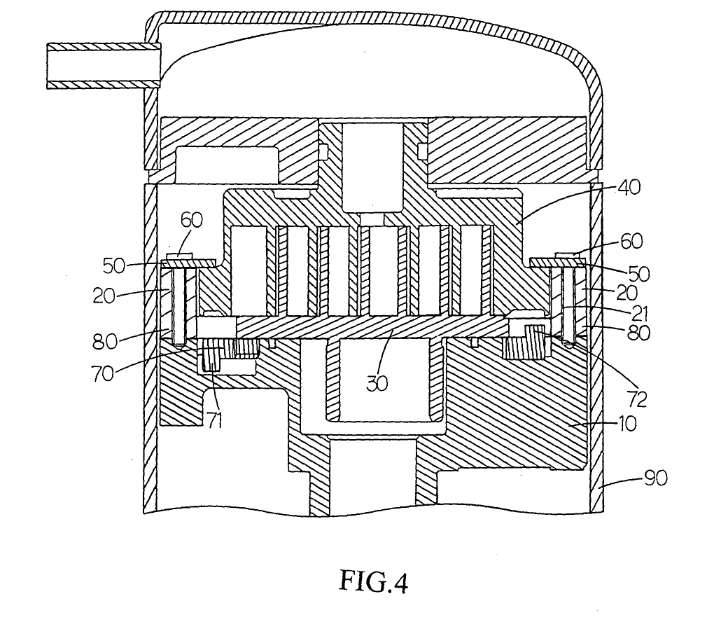

Referring to FIG. 4 for an essential structure and operation method of a compressor, an orbiting scroll (30) revolves around a fixed scroll (40) inside a casing (90) for the orbiting scroll (30) to cause multiple compression chambers in the fixed scroll (40) to respectively and inwardly increase the pressure in each compression chamber, thus to change the volume therein for compressing the coolant. A block (10) is fixed inside the casing (90) , and in turn, the block (10) is fixed to the fixed scroll (40) while the orbiting scroll (30) is provided at where between the fixed scroll (40) and the block (10) to revolve around the fixed scroll (40).

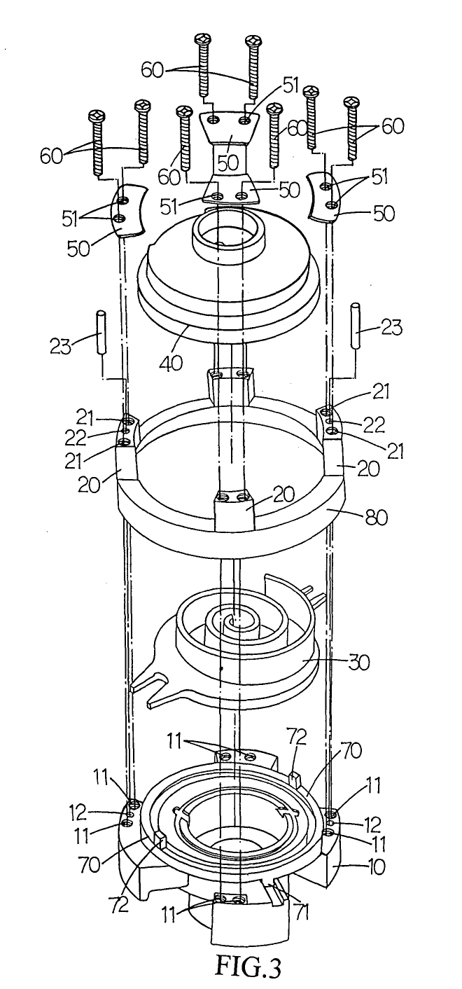

Also referring to FIGS. 3 and 4, multiple positioning seats (20) are fixed to the block (10) at where in relation to the circumference of the fixed scroll (40). A suppressor (50) is provided at the top of each positioning seat (20) to secure both of the fixed scroll (40) and the block (10) in position. Wherein, the positioning seat (20) is fixed to the block (10) by means of a stand ring (80). As shown in the preferred embodiment of the present invention, those positioning seats (20) are integrated in one piece with the stand ring (80), and corresponding through holes (21) and locking holes (11) and their relative positioning holes (22) and insertion holes (12) are respectively provided on each of those multiple positioning seats (20) and the block (10) so that the block when fixed inside the casing (90) is further inserted with multiple positioning pins (23) and then locked up with multiple bolts (60).

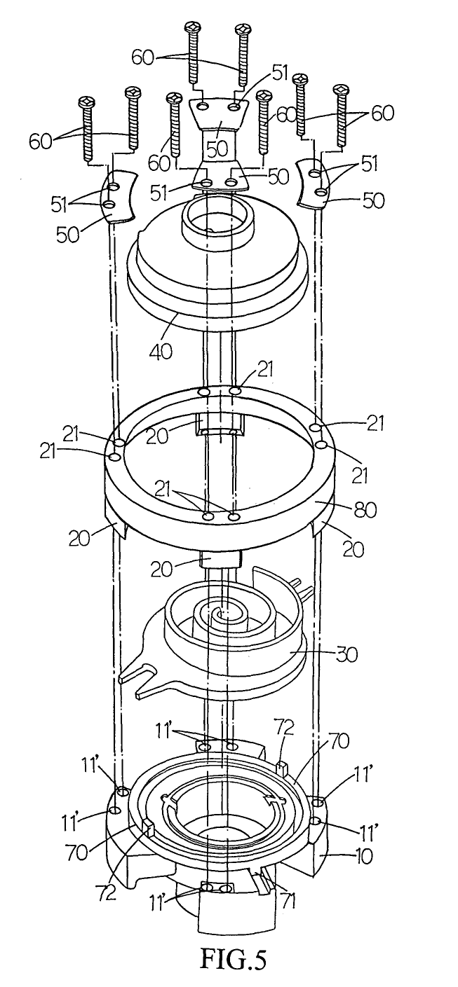

Alternatively, the structure of those positioning seats (20) and the stand ring (80) can be that as illustrated in FIG. 5, multiple corresponding through holes (21) and locking holes (11′) are respectively provided on those positioning seats (20) and the block (10). Wherein, there are no inner threads provided to the upper section of the locking hole (11′), instead, inner threads are provided on the lower section of the locking hole (11′) so that once the block (10) is fixed inside the casing (90), it is held in position by means of the positioning pins (23), and then those positioning pins are removed for insertion is of bolts (60) to lock up the block (10).

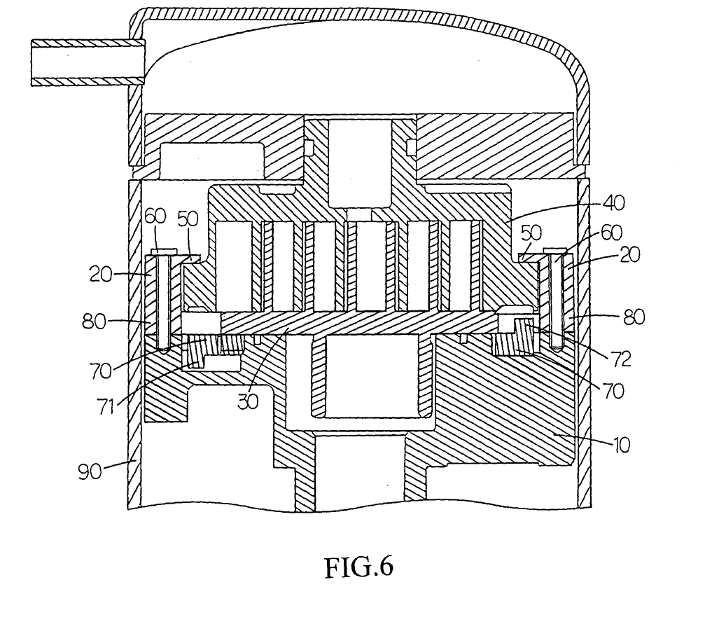

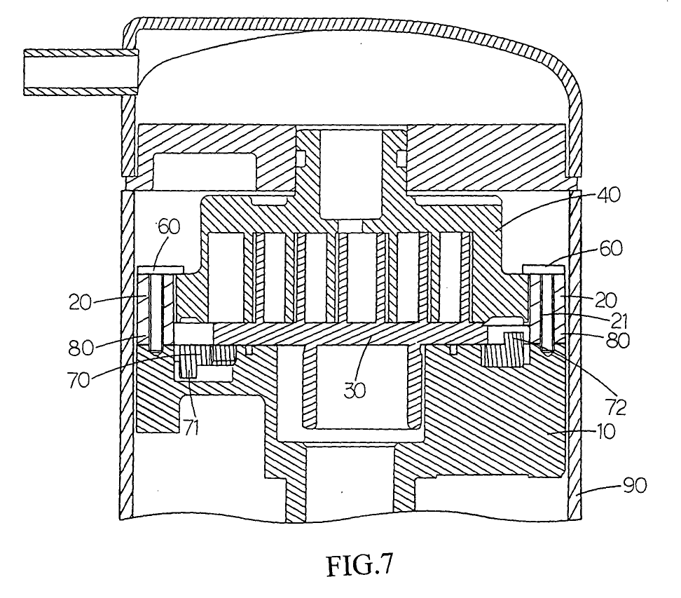

While as illustrated in FIGS. 3 and 4, the suppressor (50) is provided with multiple through holes (51) and locked in position with bolts (60) to those positioning seats (20), the stand ring (80) and the block (10) to suppress against both of the fixed scroll (40) and the block (10), it can be also as illustrated in FIG. 6, integrated in one piece with those positioning seats (20) and the stand ring (80) to exercise suppression against both of the fixed scroll (40) and the block (10) while those bolts (60) are used to lock both of the stand ring (80) and the block (10). Or, as illustrated in FIG. 7, the suppressor (50) and the bolts (6) are integrated in one piece.

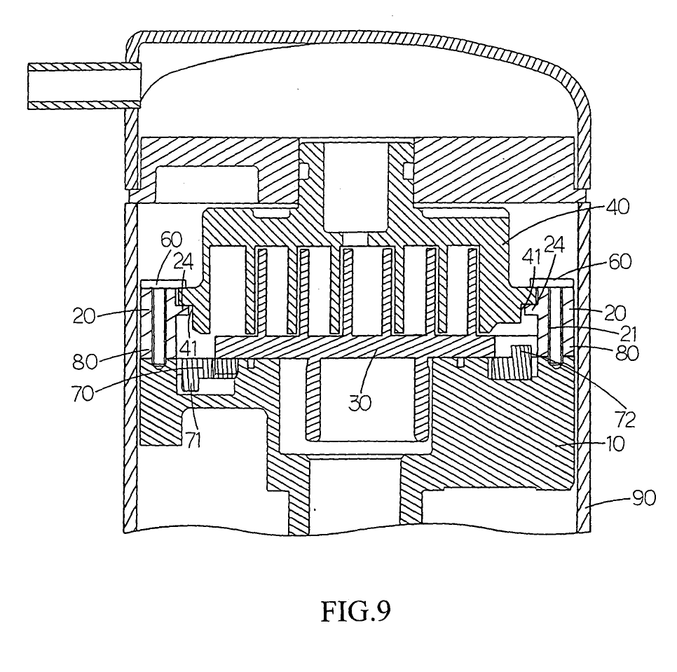

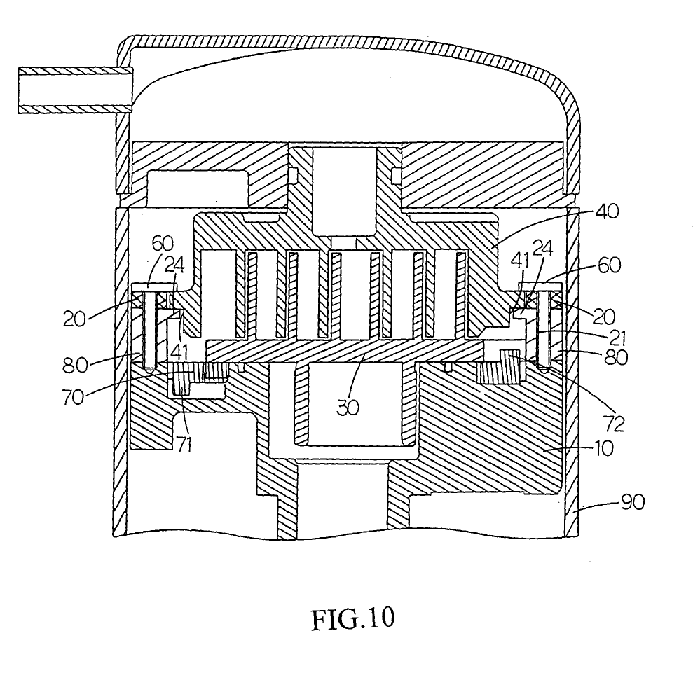

As illustrated in FIG. 9, multiple rest seats (24) protrude from the positioning seat (20) at where in relation to the circumference of the fixed scroll (40), and multiple grooves (41) are provided on the fixed scroll (40) to respectively caulk into those rest seats (24) to limit the descending level of the fixed scroll. Accordingly, a minimum spacing is maintained between the fixed scroll (40) and the orbiting scroll (30) to reduce the friction between both scrolls while the compressor is operating, so to reduce power consumption and avoid friction in the course of the operation by the compressor for a better operation efficiency of the compressor. Alternatively, the stand ring (80), those positioning seats (20) and those rest seats (24) can be arranged in the configuration as illustrated in FIG. 10.

Furthermore, as illustrated in FIG. 6, an Oldham ring (70) is provided between the orbiting scroll (30) and the block (10) in the fixation means. The Oldham ring (70) is provided with a positioning part (71) fixed to the block (10), and a limitation part (72) engaged to the orbiting scroll (30) to limit it to only revolve around the fixed scroll (40) without revolving on its own axis. Alternatively, the positioning part (71) of the Oldham ring (70) is fixed to the stand ring (80) to achieve the same purpose of holding the Oldham ring (70) in position.

As disclosed, the present invention provides an improved fixation means for the scrolls in a scroll compressor to minimize mechanical deformation of the block and the casing during the assembly process to ensure of the assembly precision for those positioning seats and the fixed scroll. Therefore, this application for a utility patent is duly filed accordingly. However, it should be noted that any and all the preferred embodiments and accompanying drawings disclosed herein do not in any way limit the present invention; therefore, any structure, means and/or characteristics that are identical with or similar to those of the prevent invention shall be deemed as falling within the purposes and claims of the present invention.

1-10. (Canceled)

11. A pumping structure of a scroll compressor with a coolant comprising:
a) a block fixedly connected to an interior of a casing of the compressor;
b) a fixed scroll fixedly connected to the block;
c) an orbiting scroll located between the block and the fixed scroll, the orbiting scroll rotating around the fixed scroll;
d) a plurality of positioning seats, each of the plurality of positioning seats being spaced apart around an exterior circumference of the fixed scroll and fixedly connected to the block;
e) a plurality of suppressors, each of the plurality of suppressors being connected to a top of one of the plurality of positioning seats and positioning the fixed scroll relative to the block;
f) an Oldham ring located between the orbiting scroll and the block and having a limitation part limiting a direction of movement of the orbiting scroll; and
g) a stand ring connecting each of the plurality of positioning seats to the block,
wherein a changing volume in a plurality of compression chambers in the fixed scroll and the orbiting scroll compresses the coolant.

12. The pumping structure according to claim 11, wherein the plurality of positioning seats and the stand ring are integrated in one piece.

13. The pumping structure according to claim 11, wherein the plurality of suppressors and the plurality of positioning seats are integrated in one piece.

14. The pumping structure according to claim 11, wherein the plurality of positioning seats, the plurality of suppressors and the stand ring are integrated in one piece.

15. The pumping structure according to claim 11, wherein the plurality of suppressors and those bolts are integrated in one piece.

16. The pumping structure according to claim 11, wherein the Oldham ring includes a positioning part fixed to the block.

17. The pumping structure according to claim 11, wherein the stand ring is coupled to the block with a plurality of positioning pins, and fixedly connected thereto by a plurality of bolts.

18. The pumping structure according to claim 11, wherein each of the plurality of positioning seats has a rest seat corresponding to one of a plurality of grooves on a bottom of the fixed scroll limiting a descending level of the fixed scroll and maintaining a minimum spacing between the fixed scroll and the orbiting scroll.

19. The pumping structure according to claim 11, wherein the stand ring, the plurality of positioning seats and each rest seat are integrated in one piece.
